(19) United States
(12) Patent Application Publication
(10) Pub. No.: US 2025/0162130 A1
(43) Pub. Date: May 22, 2025

(54) WORKBENCH WITH RECESS IN TABLETOP FOR INSERTION OF POWER TOOLS WITH ASSOCIATED TEMPLATE

(71) Applicant: William Edward Todd, Millcreek, UT (US)

(72) Inventor: William Edward Todd, Millcreek, UT (US)

(21) Appl. No.: 18/954,439

(22) Filed: Nov. 20, 2024

Related U.S. Application Data
(60) Provisional application No. 63/601,099, filed on Nov. 20, 2023.

(51) Int. Cl. B25H 1/10

(52) U.S. Cl. CPC B25H 1/10

(57) ABSTRACT

The present invention is a system and method for providing a versatile workbench that is capable of placing a plurality of different power tools on a working surface workbench, wherein each of the different power tools may be placed in a recess in the top of the workbench and have a customized template placed over the power tool such that the surface of the surrounding workbench and the template are flush with each other to thereby maximize the available working space by utilizing the workbench surface and the template surface together.

### BACKGROUND

Field of the Invention: This invention relates generally to workbenches used with power tools. More specifically, the invention relates to a workbench that is modified in order to improve the versatility of the workbench in that it provides a work surface that is adaptable to providing a plurality of templates that are disposed over the recess, wherein each template provides customized access to a particular power tool and a working surface that is level with the surrounding surface of the workbench.

Description of Related Art: There are a

variety of customized workbenches in the marketplace that enable a user to place a power tool on a workbench in a quick and easy manner. The obvious example is a workbench that has a surface on which any power tool can be placed and used on it. However, what is common to all of these workbenches is that the surface of the workbench is generally going to be below the surface of the power tool. Therefore, it may be difficult to handle a workpiece on the power tool because there is nothing to support the workpiece other than the user holding it in place. Depending on the size of the workpiece, this can be difficult, awkward, or even dangerous to the user.

To solve this problem, specialized workbenches were created that provided a larger surface when used with a specific power tool. Thus, the workbench would accommodate a single power tool, wherein the work surface was flush with the work surface of the power tool. Typically, the power tool could be removed from the workbench and the surface could then be used for other purposes.

A different solution is a workbench with a built-in power tool. The workbench is a dedicated device that is only usable with the integrated power tool and the power tool is not removable.

Another solution is a workbench that has a surface that has no power tool on it. However, a power tool can be raised or lowered or otherwise maneuvered onto the surface of the workbench using a mechanical device. In one example, a lever is pulled that causes a power tool to be lifted up, so it is accessible from the surface of the workbench. When the power toll is no longer needed, the lever is used to remove or hide the power tool, for example, by lowering the power tool behind or to the side the workbench.

One aspect that is common to all of these different examples of workbenches is that they enable only a single power tool to be either manually or mechanically raised into a position that allows a user to work with the power tool. However, the workbench is limited in the number of power tools that can be used with the workbench and provide a surface that can be flush with the surface of the power tool.

There are some advantages of a dedicated workbench that provides a flush working surface with a single power tool. One advantage is that the size of the workbench and the power tool can be minimized because it is streamlined for operation of the single power tool. But the compact design typically comes at the cost of not being expandable and operable with other power tools.

Accordingly, it would be an advantage over the prior art to provide a workbench that enables 1) more than one, and typically any number of power tools, to be used with a single workbench, 2) provides optimized access to the working portion of the power tool, 3) provides a working surface that is always flush with the working surface of the different power tools, and 4) provides a workbench having either a compact or larger design.

### BRIEF SUMMARY

The present invention is a system and method for providing a versatile workbench that is capable of placing a plurality of different power tools on a working surface workbench, wherein each of the different power tools may be placed in a recess in the top of the workbench and have a customized template placed over the power tool such that the surface of the surrounding workbench and the template are flush with each other to thereby maximize the available working space by utilizing the workbench surface and the template surface together.

In a first aspect of the invention, the recess within the workbench includes a support platform that is adjustable to lift any power tool to the proper height within the workbench.

In a second aspect of the invention, a customized template is then placed over the power tool to cover up the recess and provide an uninterrupted surface for the power tool and the workbench.

In a third aspect of the invention, the recess includes a lip on which a plurality of different templates can rest.

In a fourth aspect of the invention, other devices may also be disposed on the lip of the recess besides power tools.

In a fifth aspect of the invention, the workbench may include a plurality of other features that enhance the functionality of the workbench.

In a sixth aspect of the invention, the workbench may be disposed on a mobile cart or include wheels such that the workbench is a mobile structure.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of the front of the workbench showing three main sections, including a recess for a power tool and additional compartments for other devices and storage.

FIG. 2 is a perspective view of a hole through the workbench where a template is inserted to rest on a lip structure.

FIG. 3 is a front view of the workbench showing where a power tool is inserted into the workbench and where it rests on a support structure that keeps the power tool in the proper position to keep a top surface of the template and the planar working surface of the workbench flush with respect to each other.

FIG. 4 is a profile view of a sanding unit that may be used with the present invention, showing the power tool and a working tool end.

FIG. 5 is a profile view of the template and a hand-held power tool that is attached to the bottom surface of the template.

FIG. 6 is a top view of a template which is now resting on a supporting lip within the recess, wherein a blade of the power tool is shown extending upwards through the template, and the template includes guide rails or tracks on which other devices may be connected.

FIG. 7 is a top view of a light box structure that has been lowered into the recess and onto the supporting lip, the light box including a plurality of lights.

FIG. 8 is a top view of a tray with a hole in the bottom center of the tray to which a vacuum hose is attached, transforming the tray into a dust collector.

FIG. 9 is a perspective view of a template for the tray of FIG. 8 which provides a work surface, and which allows dust to fall through the work surface into the underlying dust tray.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

While many workbenches include modifications to work with one or two different power tools, these prior art workbenches are typically modified to only provide a workable space for one specific tool that is mechanically attached to the workbench so as not to be removable. While the power tool may be capable of being moved or lowered away from the working surface, it is still attached to the workbench.

The present invention is a substantial improvement over the prior art because it turns a workbench into a customizable system for optimizing work with any power tool that can be disposed into a recess in the middle of the workbench.

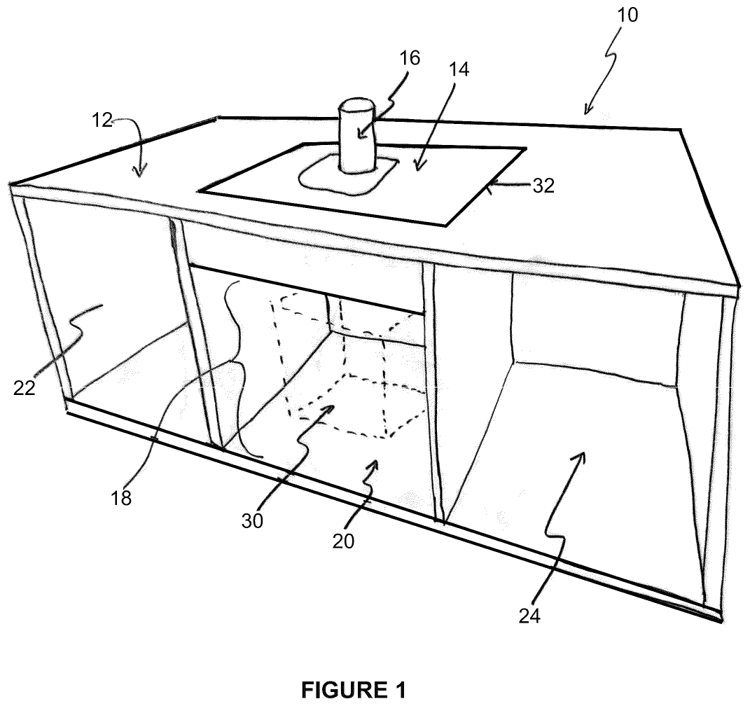

Beginning with FIG. 1, the first embodiment of the present invention is a perspective view of a workbench 10 showing a working surface 12, an installed template 14, and a working portion of a tool 16 disposed through the template. In the front and exposed section of the workbench are shown as three separate sections. However, the workbench 10 below the working surface 12 may have any number of separate compartments and is shown with three compartments only as an example.

A left compartment 22 and a right compartment 24 may be used for various purposes. For example, a vacuum unit, shelves, power tools, templates and any other item that the user needs may be stored in them. However, a center compartment 20 is used as a recess 18 under the template 14 of the working surface 12.

The function of the recess 18 is to provide a place within the workbench to support a power tool 16 that is disposed within the recess and supported by an appropriate support structure 30. The support structure 30 may be any support structure that enables the power tool 16 to rest at a proper height within the recess 18, relative to the working surface 12 of the workbench 10.

The support structure 30 may be an item that is removable from the center compartment 20, or it may be secured to the compartment. The support structure 30 may be a static device or it may include components that are movable. For example, the support structure 30 may be as simple as a box or stool, or it may be a mechanical lift such as a jack that can me operated to move the power tool 16 up and down within the recess 18. The support structure 30 may be able to be secured to the center compartment 20 using straps, hooks, or any other means.

In the first embodiment of the invention, the center compartment 20 shows the recess 18 that is accessed from the front and top of the workbench 10. FIG. 1 also shows a rectangular template 14 disposed in a hole 32 through the top of the workbench 10 and down into the recess 18.

The recess may be any shape but should be large enough to accommodate any power tool that the user wants to use with the workbench 10. While the first embodiment uses a rectangular shape for the templates, this should not be considered as a limitation of the workbench 10. Accordingly, the templates may be any desired shape as long as they are the same shape as the hole 32 in the work surface 12.

The recess 18 is shown as being accessible at the front of the workbench 10 so that the power tool 16 may be easily moved under the hole 32. However, it may be possible that the height or shape of the power tool 16 is too large to fit into the recess 18. Accordingly, the power tool 16 may be lowered into the recess 18 through the hole 32 and either placed on a support structure 30 or on the bottom of the recess.

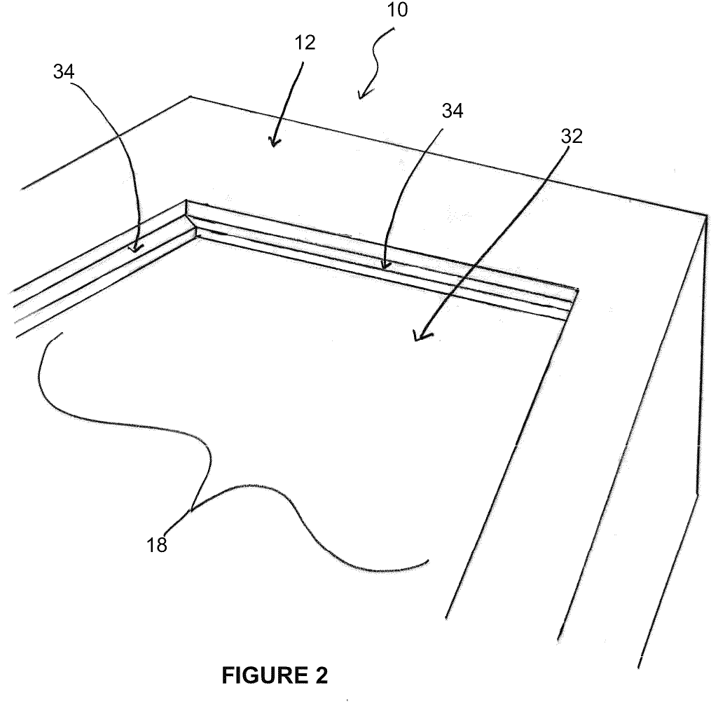

FIG. 2 shows a partial perspective view of the work surface 12 of the workbench 10. The recess 18 includes a lip structure 34 around the perimeter of the hole 32 in the workbench 10 in order to support the template 14 and keep it from falling into the center compartment 20. The lip structure 34 in the hole 32 is clearly visible in the recess 18 in the workbench 10

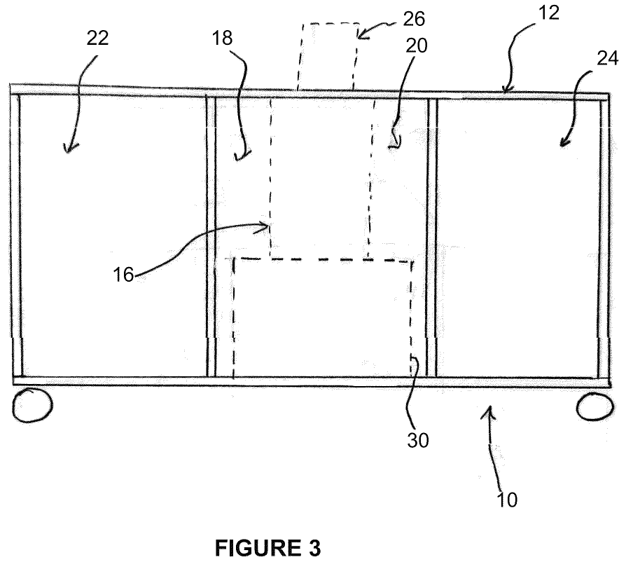

FIG. 3 is a front view of the workbench 10 showing the center compartment 20 which also functions as the recess 18. FIG. 3 shows that there is an undefined support structure 30 at the bottom of the recess 18. The support structure 30 may be of any height, width, depth and overall shape. The support structure 30 may be a single object or a plurality of different objects that serve the function of supporting the power tool when it must be disposed into the recess 18 of the workbench 10. The support structure 30 may make contact directly with the power tool or with a base structure of the power tool. The support structure 30 may also be secured or movable within the recess 18 and may or may not be connected to the bottom of the recess.

FIG. 3 also shows a power tool 16 that is disposed on top of the support structure 30. Note that the height of the support structure 30 is precisely the height needed to keep the power tool 16 at the proper height so that a tool portion 26 of the power tool is kept flush with the template 14 and the template is flush with the working surface 12 of the workbench 10.

It is noted that the outline of the power tool 16 and the tool portion 26 of the power tool is shown as being undefined because it may be any shape and size as long as it can fit within the recess 18.

FIG. 3 shows that the support structure 30 may be stored in the bottom of the recess 18 or stored apart from the workbench 10.

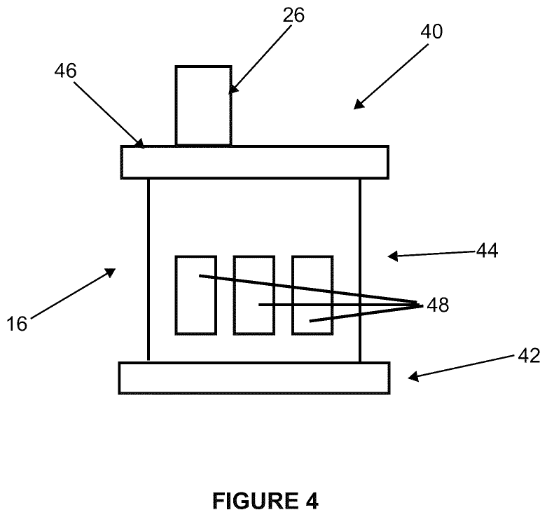

FIG. 4 is a profile view of a sanding unit 40. The sanding unit 40 may have a base 42, a body 44, a working surface 46, and a tool portion 26 that is disposed on a spindle. The base 42 may have attachment points where it can be secured to a structure that provides stability to the sanding unit 40. The sanding unit 40 may include various attachments such as additional tool portions 26.

The height of the support structure 30 at the bottom of the recess 18 is the precise height needed to bring the working surface 46 of the sanding unit 40 to the same level as the template 14 that is disposed over the sanding unit. This is shown in FIG. 1 where the working surface 46 of the sanding unit 40 is the same height as the template 16 and the same height as the working surface 12 of the workbench 10.

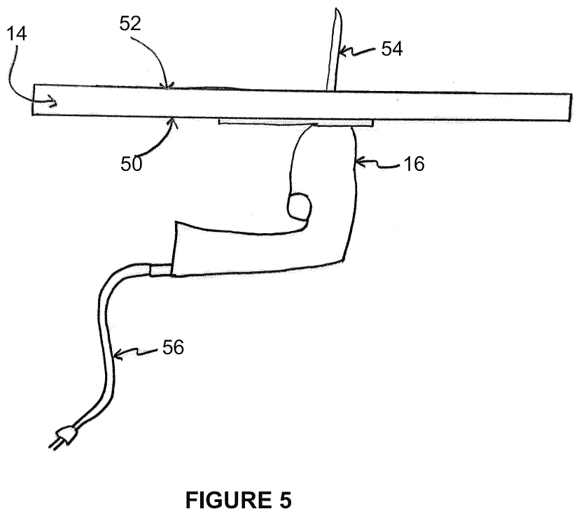

FIG. 5 shows that while the use of the support structure 30 at the bottom of the recess 18 is useful for some power tools 16, the support structure may not always be needed. For example, FIG. 5 in a profile view shows a template 14 for using a power tool 16 such as a jigsaw in the first embodiment of the workbench 10. In this case where the power tool 16 has no stand because it is a handheld device, the power tool is attached to a bottom surface 50 of the template 14 by any appropriate means. The blade 54 of the power tool 16 extends through the template 14 and extends above a top surface 52 of the template. The template 14 is lowered onto the hole 32 of the recess 18 until it hits and rests on the lip structure 34. Because the power tool 16 is attached to the bottom surface 50 of the template 14, there is no need to provide the support structure 30 in the bottom of the recess 18.

Accordingly, the support structures in the recess are not always needed. However, it should be understood that the support structure for the jigsaw or other power tools that are suspended from the bottom of the template 14 may still be provided when needed in order to bring added support and rigidity to the power tool 16.

The power cord 56 of the power tools that are disposed in the recess 18 must also be placed into the recess as the template 14 is placed on the lip structure 34 inside the recess. The power cord 56 is then plugged into an electrical outlet disposed in the recess 18.

It is noted that there are various mechanical devices for mechanically depressing a trigger of a power tool 16. These activation devices may be activated and deactivated by a switch. The switch may be located in any conveniently located position on the workbench 10. A system for activating and deactivating the one and off switch of a power tool is considered to be known to those skilled in the art and is not considered a protectable feature of the first embodiment by itself but is considered protectable as part of the first embodiment.

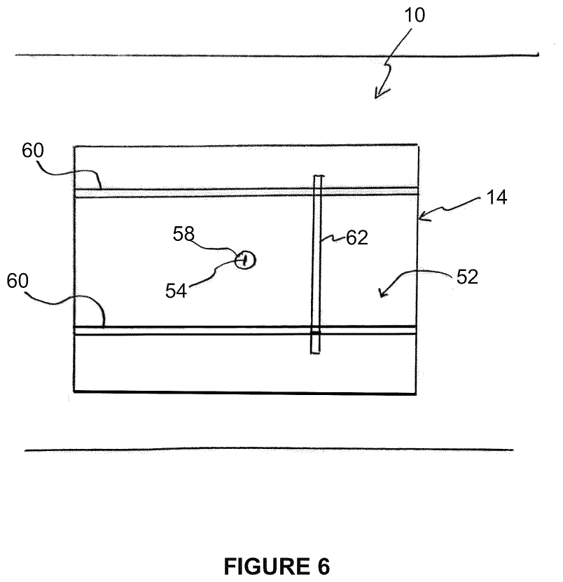

FIG. 6 is a top view of the workbench 10 and the top surface 52 of the template 14 for the power tool 16 shown in FIG. 5. The blade 54 of the power tool 16 is visible through a hole 58 in the template 14. What is also shown in the template 14 is a feature that may or may not appear in a template of a particular power tool 16. In this case, the template 14 includes two guide rails 60 on opposite sides of the hole 58. The guide rails 60 may provide a groove that other tools can be attached to. For example, another guide tool 62 may be attached to both of the guide rails 60. The new guide rail 62 may be used as a guide to obtain a straight cut in a workpiece that is being cut by the blade 54. Furthermore, the guide rail 62 may also be anchored at a precise angle in order to cut a workpiece at a precise angle.

Therefore, the templates 14 may include various tracks or guide rails 60 in the top surface of the template 14 to assist in precise positioning of workpieces on the template.

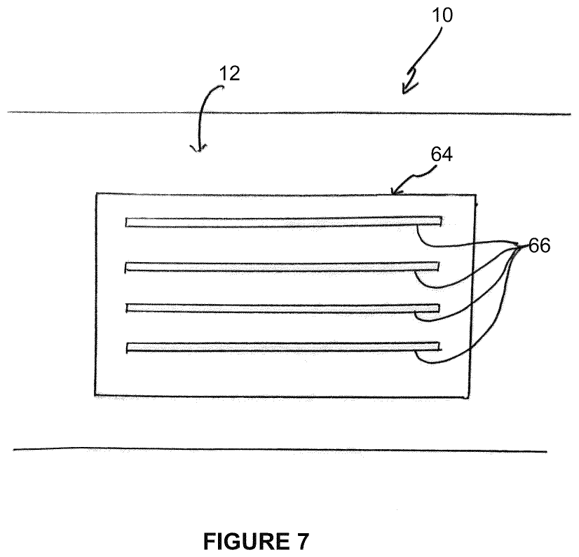

FIG. 7 is a top view of the working surface 12 of the workbench 10. The template 14 has been removed and replaced with a different type of an insert in the hole 32. In FIG. 7, the template is replaced with a light box 64 having a plurality of lights 66. Thus, the hole 18 may also be used to provide a convenient space for devices other than power tools and provide added functionality to the workbench 10. A translucent panel would then be placed over the lights 66. The translucent panel is positioned so that it is also flush with the working surface 12 of the workbench 10.

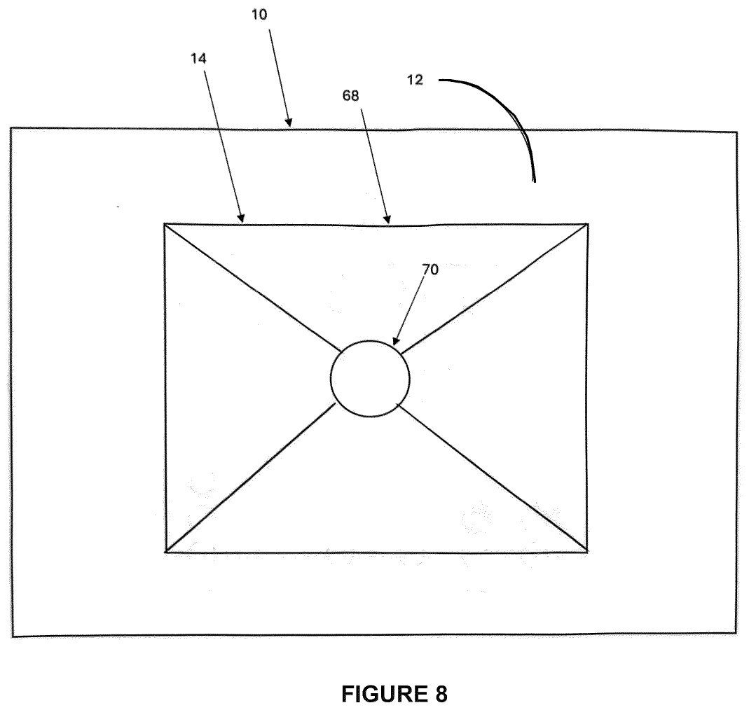

FIG. 8 is a top view of another type of device that may be disposed in the hole 32 of the workbench 10. The figure shows a dust tray 68 having an aperture 70 disposed in the middle of the dust tray 68. The aperture 70 may be coupled to a vacuum tube that is coupled to a vacuum unit in the workbench 10.

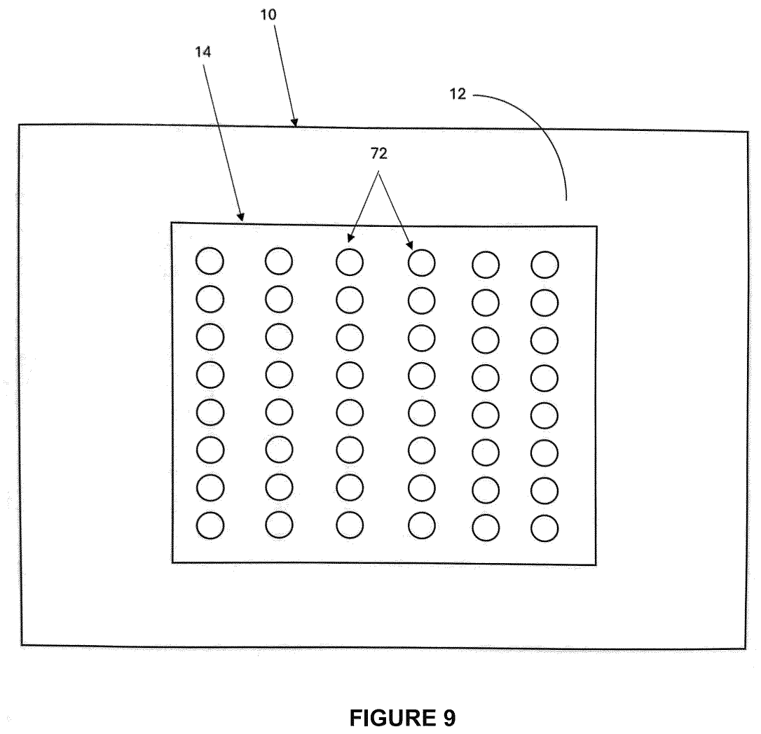

FIG. 9 is a top view of the template 14 that is disposed over the dust tray 68. The template 14 includes a plurality of holes 72 disposed therein. A workpiece may rest on the template 14 while it is being worked on. Dust from the workpiece may fall or be sucked through the holes 72 of the template 14 and be vacuumed into the vacuum unit of the workbench 10.

The number and variety of power tools 16 that may be used with the first embodiment of the workbench is only limited by the size of the recess 18 and the hole 32 in the workbench 10. Accordingly, the size of the recess 18 and the hole 32 and the templates 14 may be made increased to accommodate any desired power tool. Likewise, the corresponding templates 14 may be manufactured to accommodate any size hole 32. Similarly, the support structure 30 may be modified to accommodate any power tools 16 within the recess 18.

It is observed that if the recess 18 is not closed at the front end of the workbench 10, then a template 14 may be used that is larger than the hole 32 and extends beyond the dimensions of the workbench.

The power tools 16 should be considered to include any device that works with any medium such as wood or metal. However, other devices may also be disposed in the recess including the devices already shown in the figures above such as the light box 64 and the vacuum tray 68. Other devices may include a paper shredder and devices that are not for working with wood or metal.

Another feature of the present invention is that it is not limited to only providing a flat surface for working with power tools. While it may be advantageous to provide a planar surface for most power tools, a tilting or non-planar surface may also be needed for a particular purpose or a particular power tool. Accordingly, templates 14 may also be provided that present a non-planar surface for working with power tools. The template 14 may still rest on the lip structure 34 and yet provide a non-planar surface.

Therefore, the extreme adaptability of the workbench 10 to accommodate different objects that may be disposed within the recess 18 is one of the advantages of the present invention. Any power tools 16 should be considered to fall within the scope of power tools that may be disposed within the recess of the workbench 10.

A workbench with interchangeable templates offers significant advantages for versatility, precision, and efficiency in a workspace. For example, versatility is a tremendous advantage. The recess and template allow various power tools (e.g., routers, jigsaws, sanders) to be installed as needed, effectively turning the workbench into a multi-functional station.

Customizable templates provide the ability to swap templates and adapt the workbench for different tools and tasks without requiring multiple workbenches. Furthermore, instead of requiring separate workstations for each tool, one bench serves multiple purposes, and thereby conserving valuable workspace.

Providing a flush surface between the workbench surface and the templates ensures a seamless, even work area. This flush work surface minimizes errors caused by uneven surfaces and improves accuracy for tasks like cutting or sanding.

The invention also provides increased stability. The recess enables the user to secure the power tool firmly to the workbench if needed, reducing vibrations and movement, which enhances precision in detailed work.

The templates also standardize tool positioning, ensuring repeatable and reliable results across different projects.

The workbench provides ease of use of power tools. Templates also make possible quick power tool changes because the interchangeable templates and recess system simplify swapping out tools, saving time and effort during multi-step projects.

The flush surface and integrated setup of the templates provide a comfortable, user-friendly workspace that is an ergonomic design that reduces strain during prolonged use of the workbench.

In addition, built-in guides in the templates in the form of guides, fences, or tracks may be tailored to the specific power tool being used, making complex operations easier and safer.

The system of a recess and templates in a workbench also makes possible improved safety. By providing secure mountings for the support structure of the power tools, the power tools are firmly seated, reducing the risk of tipping or shifting during operation.

One of the main advantages of the first embodiment is providing a uniform work surface. Providing a flush surface between the power tools and the rest of the workbench eliminates obstructions, reducing the chance of material catching or snagging on uneven edges.

There is also improved safety because of integral debris and dust management. Many templates can include dust collection ports specific to each power tool, maintaining a cleaner and safer workspace.

By providing a single workbench with a plurality of different templates ensures cost efficiency. Investing in one high-quality workbench with a modular system of templates and power tools reduces the need for separate, single-purpose workbenches. Furthermore, additional templates can be created or purchased over time, extending the workbench's functionality without significant additional investment.

Finally, it is important to consider project flexibility. Transitioning between tasks is faster, as users can easily change power tools and templates without needing to reconfigure the workspace around the workbench. The workbench also accommodates complex projects when projects require multiple tools, as it reduces the need to move materials between different workstations.

One alternate embodiment of the invention may be a workbench that is suitable for performing work with water. The workbench may include a water inlet, a water drain, a sink, a sink liner, a water tank, and a pump or gravity feed design.

Another alternative embodiment may be a scaled-down light duty version for hobbyists, carvers, and model makers. There are a large number of small or miniature power tools available for use and a miniature workbench could be made for scaled down use. The workbench could be scaled down to a table-top design but still provide the templates and a recess for the various miniature power tools.

Similarly, a lightweight but much larger version could be created as a mobile workbench. The workbench might be bolted to an inner wall of a semi-trailer to create a mobile mill. The workbench would be just one component of a much larger mobile workshop.

The variety of templates 14 that may be created is endless. The important features of a template 14 are that it be large enough to sit on the lip structure 34 in the workbench 10, that it include one or more holes, slots, or other types of apertures through the template 14 such that a working tool end of a power tool is able to extend through the template to be used. The template 14 may also include guide rails, tracks, or fences to assist the user in modifying a workpiece.

Templates 14 may be created for power tools 16 that include, but should not be considered as limited to, an inverted circular saw, an inverted jigsaw, an inverted router, a spindle sander, a table saw, a T-track table, a Kaufman dowel jig, a platen sander, a down draft table, a paper shredder, and a light table. Templates 14 may also be created as an end grain cutting board, turntable, almond melamine blank, white melamine blank, Baltic birch blank, and an OSB blank.

Other devices that may need modification to be used with the workbench but could be modified do include, but should not be considered as limited to, a saw stop compact table saw, a portable edge bander, a benchtop jointer, a benchtop planner, a benchtop jointer/planer combo, a bandsaw modified as double tilt scroll saw, a scroll saw, a benchtop drill press, an oscillating drill press, a bench top mortiser, a wood lathe, an oscillating spindle sander, a benchtop oscillating sander, a benchtop oscillating sander, an edge sander, a benchtop down draft table, a CNC router, a CNC laser, a hinge boring machine, a sliding miter saw, a mini benchtop cut off saw, a benchtop tile saw, a benchtop router table, and a pocket hole machine. This list should not be considered as exhaustive but only as possible devices that may be disposed in the first embodiment of the invention with an appropriately designed template.

In summary, a first embodiment of the invention is a system to enable a variety of different power tools to operate with the same workbench and provide a planar working surface that extends to the workbench, said system comprising a workbench having the planar working surface, an access hole cut through the planar working surface, at least one compartment below the planar working surface that forms a recess below the access hole, a lip structure in the access hole, a first template that rests on the lip structure within the access hole such that a top surface of the template is substantially flush with the planar working surface of the workbench, a first power tool that rests on a support structure within the recess below the access hole, and wherein the first power tool includes a working tool end that extends through the first template such that the working tool end rises above the top surface of the template and the planar working surface of the workbench.

The first embodiment provides a plurality of templates and power tools, wherein each template is associated with at least one power tool, wherein each power tool with its associated template includes at least one hole or slot in the associated template that enables a working tool end of the power tool to extend through the associated template so that the working tool end may be used when the power tool and the associated template are both disposed in the workbench.

A summary of the method of the first embodiment includes providing a workbench having the planar working surface, an access hole cut through the planar working surface, at least one compartment below the planar working surface that forms a recess below the access hole, a lip structure in the access hole, a first template that rests on the lip structure within the access hole such that a top surface of the template is substantially flush with the planar working surface of the workbench, and a first power tool that rests on a support structure within the recess below the access hole, and extending a working tool end of the first power tool through the first template such that the working tool end rises above the top surface of the template and the planar working surface of the workbench.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A system to enable a variety of different power tools to operate with the same workbench and provide a planar working surface that extends to the workbench, said system comprising:
a workbench having the planar working surface;
an access hole cut through the planar working surface;
at least one compartment below the planar working surface that forms a recess below the access hole;
a lip structure in the access hole;
a first template that rests on the lip structure within the access hole such that a top surface of the template is substantially flush with the planar working surface of the workbench;
a first power tool that rests on a support structure within the recess below the access hole; and
wherein the first power tool includes a working tool end that extends through the first template such that the working tool end rises above the top surface of the template and the planar working surface of the workbench.

2. The system as defined in claim 1 wherein the system further comprises:
a plurality of power tools; and
a plurality of templates, wherein each template is associated with at least one power tool, wherein each power tool with its associated template includes at least one hole or slot in the associated template that enables a working tool end of the power tool to extend through the associated template so that the working tool end may be used when the power tool and the associated template are both disposed in the workbench.

3. A method for enabling a single workbench to accommodate a variety of different power tools and provide a planar working surface that extends to the workbench, said method comprising:
providing a workbench having the planar working surface, an access hole cut through the planar working surface, at least one compartment below the planar working surface that forms a recess below the access hole, a lip structure in the access hole, a first template that rests on the lip structure within the access hole such that a top surface of the template is substantially flush with the planar working surface of the workbench, and a first power tool that rests on a support structure within the recess below the access hole; and
extending a working tool end of the first power tool through the first template such that the working tool end rises above the top surface of the template and the planar working surface of the workbench.
